(19) United States
(12) Patent Application Publication
(10) Pub. No.: US 2006/0220326 A1
(43) Pub. Date: Oct. 5, 2006

(54) MULTILOBE GASKET AND SEALING GROOVE

(75) Inventors: Max Leadley-Brown, Edinburgh, Scotland (GB); Steve Buchan, Perth, Scotland (GB); Ian Grant, Edinburgh, Scotland (GB)

Correspondence Address: BABCOCK IP LLC, 24154 LAKESIDE DRIVE, LAKE ZURICH, IL, 60047, US

(73) Assignee: ANDREW CORPORATION, Orland Park, IL (US)

(21) Appl. No.: 10/907,345

(22) Filed: Mar. 30, 2005

(51) Int. Cl. F16L 17/06

(52) U.S. Cl. 277/609

(57) ABSTRACT

A sealing gasket and corresponding sealing groove pair formed in mating sealing surface(s). The sealing gasket has a cross section with a plurality of lobes in a generally H-shaped configuration. The sealing groove(s) are formed with a groove bottom between opposing groove side(s); the groove bottom having a middle ridge projecting towards an open end of the groove(s). The sealing gasket compresses and seals against the sealing groove(s) as the sealing surface(s) are mated against each another. Each groove side may also have a recess shoulder at the sealing surface.

### BACKGROUND

Sealing gaskets retained by a sealing groove are commonly applied to electrical enclosures and RF structures to form particle and moisture seals for the prevention of environmental degradation to the enclosed contents and or internal surfaces. Static seals on many forms of electrical and RF equipment are required to maintain their effect over the full service life of the device(s), which may be installed in extreme environments such as upon radio towers.

Prior sealing gasket solutions include a thick overpaint, applied foam or liquid bead seals, and pre-formed rubber bootlace type circular and or rectangular cross-section o-rings. Liquid bead seals are messy and time consuming to accurately apply. Excess liquid bead material may also inadvertently spread from the desired sealing groove area, obstructing proper seating of the sealing surfaces and or fouling internal surfaces. Pre-formed sealing gaskets must be selected to adequately seal the expected range of grove tolerances without being too small to adequately seal or being so large that the sealing gasket is pinched in the mating surfaces outside of the sealing groove(s).

A sealing gasket has a compression characteristic that allows the sealing gasket to fill and seal between sealing surfaces as the sealing surfaces are mated around the sealing gasket. As seals are applied to smaller and smaller assemblies, the corresponding sealing gasket and sealing grooves are also reduced in dimension, reducing the sealing gasket area available for compression and thereby the compression characteristic of the sealing gasket. As the compression characteristic of the selected sealing gasket is reduced, the required precision of the sealing surfaces, sealing gasket and sealing grooves necessary to obtain a reliable seal are increased, significantly increasing manufacturing costs.

Sealing gaskets having resilient arm configurations typified by variations of X, Z, M or V cross sections are adapted to bend in addition to or instead of compressing, often with the assistance of a metallic spring member, forming a bias seal dependent on the longevity of the bias of the resilient arm(s) against and or between the groove side walls. These gasket and associated groove configurations may also be difficult to manufacture with the necessary precision when sized for smaller sealing grooves and are typically either unreliable for long term static sealing applications and or require use of specialized gasket materials and or spring member(s) that are not cost effective.

The increasing competition for smaller enclosures and RF structures has focused attention on cost reductions resulting from increased materials, manufacturing and service efficiencies. Further, reductions in required assembly operations and the required level of manufacturing precision are desired.

Therefore, it is an object of the invention to provide an apparatus that overcomes deficiencies in the prior art.

### BRIEF DESCRIPTION OF THE DRAWINGS

The accompanying drawings, which are incorporated in and constitute a part of this specification, illustrate embodiments of the invention and, together with the general and detailed descriptions of the invention appearing herein, serve to explain the principles of the invention.

FIG. 1 is a schematic cross section of an exemplary embodiment of a sealing gasket according to the invention.

FIG. 2 is a schematic cross section of an exemplary embodiment of a pair of sealing surfaces having sealing groove(s) according to the invention.

FIG. 3 is a schematic cross section of the gasket of FIG. 1, in position within the sealing groove(s) of the sealing surfaces of FIG. 2, prior to mating of the sealing surfaces together.

FIG. 4 is a schematic cross section of the gasket of FIG. 1, compressed within the sealing groove(s) of the mated sealing surfaces of FIG. 2.

### DETAILED DESCRIPTION

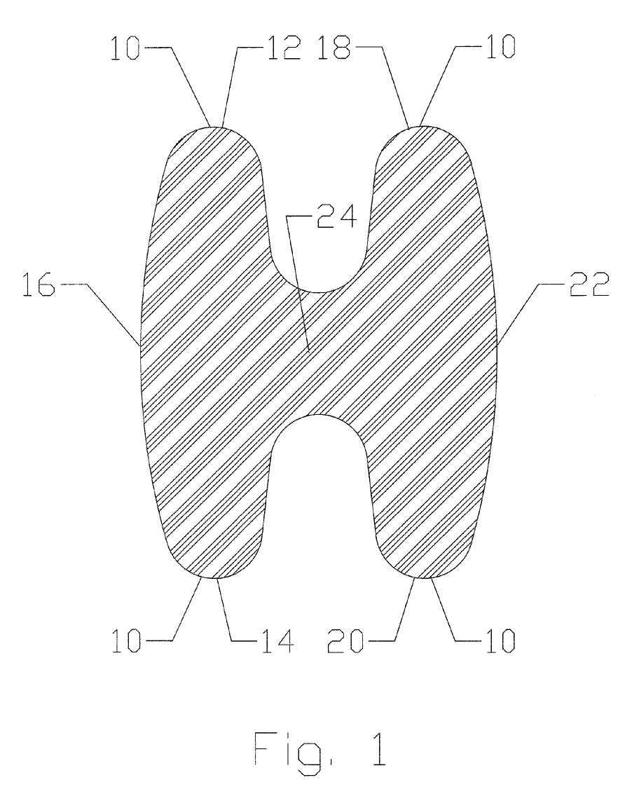

The invention will be described with reference to an exemplary embodiment of a sealing gasket and sealing groove(s) according to the invention, as shown in FIGS. 1-4.

The sealing gasket 8, as shown in FIG. 1 has a plurality of lobe(s) 10 arranged to give the sealing gasket a generally H-shaped cross section. A first upward projecting lobe 12 and a first downward projecting lobe 14 of the sealing gasket 8 are vertically aligned on a first side 16 of the sealing gasket 8 and a second upward projecting lobe 18 and a second downward projecting lobe 20 of the sealing gasket 8 are vertically aligned on a second side 22 of the sealing gasket 8. Thereby dual vertical gasket structure(s) are formed, compression sealing rather than bias sealing as corresponding sealing groove(s) are seated around the sealing gasket 8. The dual vertical gasket structures are joined together at a mid section 24 of the sealing gasket 8. The mid section 24 connection of the dual vertical gasket structures, stabilizes one another in the proper vertical orientation during sealing gasket 8 installation in the sealing groove(s) 26. The sealing gasket 8 may be formed from any of a number of different gasket materials such as viton, silicon, epdm and rubber, selected for the expected environmental conditions, life cycle and cost constraints of the desired application.

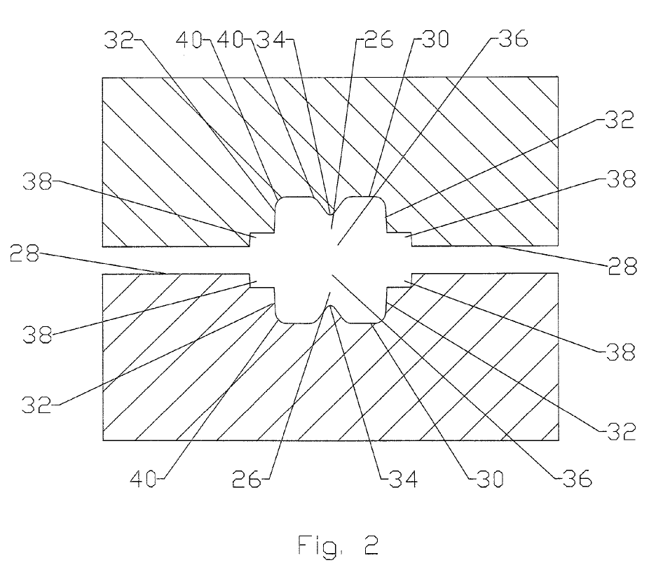

The sealing groove(s) 26, as shown for example in FIG. 2, are formed in corresponding sealing surface(s) 28. Each of the sealing groove(s) 26 has a groove bottom 30 between opposing groove side(s), 32 the groove bottom 30 having a middle ridge 34 projecting towards an open end 36 of each sealing groove 26. The middle ridge 34 may be formed with a generally triangular cross section and may have a peak height from the groove bottom 30, for example, of at least 25 percent of a depth from the sealing surface 28 of the sealing groove 26.

One skilled in the art will appreciate that the sealing groove(s) 26 and mating sealing gasket 8 according to the invention may be applied to a wide range of varied applications and or apparatus, the sealing surface(s) 28 and sealing groove 26 routed along a periphery of areas to be sealed as desired. One particular application of the invention is the static sealing of the mating surfaces between two halves of split block RF waveguide components such as diplexers.

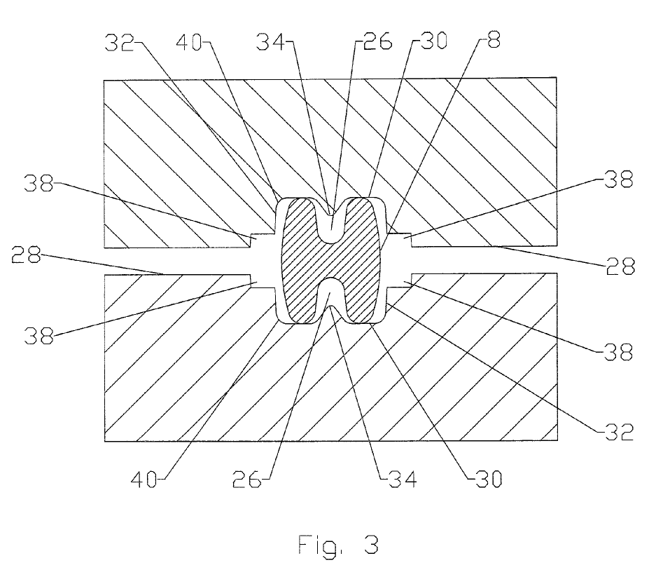

As shown in FIG. 3, the sealing gasket 8 or alternatively the sealing groove(s) 26 may each be sized with respect to target dimensions of the other component. The sealing gasket 8 generally has a width less than a width of the sealing groove(s) 26 and a height that is greater than a combined depth of the sealing groove(s) 26.

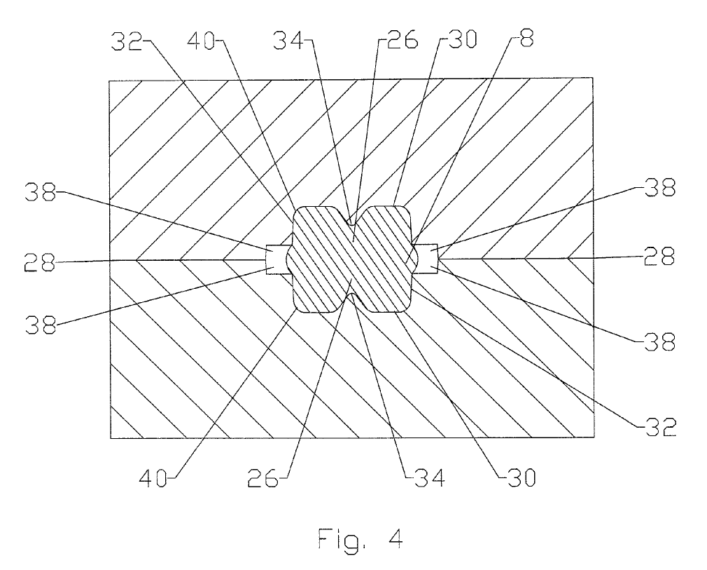

As the sealing surface(s) 28 are mated together enclosing and compressing the sealing gasket 8, as shown in FIG. 4, the dual vertical gasket structures each are compressed along their vertical extent. The middle ridge 34 of each sealing groove 26 operates to guide the dual vertical gasket structures as they are compressed, preventing them from buckling side to side as compression is applied. Mating the sealing surface(s) 28 together results in compression of the sealing gasket 8 that fills the sealing groove(s) 26, sealing along an extended sealing surface of each sealing groove 26 created by the presence of each middle ridge 34.

A recess shoulder 38 may be applied to each groove side at the sealing surface to provide an area for excess sealing gasket 8 material to expand into, preventing the sealing gasket 8 from being pinched between the sealing surface(s) 28.

The dual vertical gasket structures, and the recess shoulder(s) 38 combine to extend the acceptable combined variance of sealing gasket 8 and or sealing groove 26 dimensions which will co-operate to acceptably seal together. A larger than optimal sealing groove 26 and or smaller sealing gasket 8 will at least have dual seals provided by the dual vertical gasket structure as long as the combined depth across the sealing groove(s) 26 when the sealing surface(s) 28 are seated upon one another is not larger than the height of the sealing gasket 8. Similarly, as the height and or width of the sealing gasket 8 and or sealing groove(s) 26 varies towards an acceptable minimum or maximum dimension, respectively, the recess shoulder(s) 38 operate to absorb excess compressed sealing gasket 8 volume before the sealing gasket 8 becomes unacceptably pinched between the sealing surface(s) 28. Due to the dimensional variance allowed by the present invention, the sealing surface(s) 28 and sealing groove(s) 26 may be cost efficiently manufactured, for example, via die casting.

To enable the compressed sealing gasket 8 to entirely fill the sealing groove(s) 26 without voids, and also improve die casting characteristics of the sealing surface(s) 28 and sealing groove(s) 26, the transition 40 between each of the groove side(s) 32 and the groove bottom 30, and between the groove bottom 30 and the bottom ridge 34 may be rounded.

The invention has been demonstrated with an exemplary embodiment where the sealing groove(s) 8 are shown dimensionally equal to one another, maximizing the length of the shortest potential leakage path around the sealing gasket 8. Alternatively, the depth of the sealing groove(s) 8 may be adapted as desired. A first sealing surface with a first sealing groove and a second sealing surface with a second sealing groove may have different depths, with one or the other having a deeper groove, for example, providing a more secure nest for the sealing gasket 8 prior to mating of the sealing surface(s) 28 together. Whatever the respective sealing groove 26 depths are, the sealing gasket will similarly seal between them if the combined first and second sealing groove depth when mated together is less than a height of the sealing gasket 8.

The present invention provides a sealing gasket 8 and sealing groove 26 adapted to reliably seal together despite increased dimensional variances, thereby enabling use of materials and manufacturing processes with improved cost efficiencies.

Table of Parts

| | |
|---|---|
| 8 | sealing gasket |
| 10 | lobe |
| 12 | first upward projecting lobe |
| 14 | first downward projecting lobe |
| 16 | first side |
| 18 | second upward projecting lobe |
| 20 | second downward projecting lobe |
| 22 | second side |
| 24 | mid section |
| 26 | sealing groove |
| 28 | sealing surface |
| 30 | groove bottom |
| 32 | groove side |
| 34 | middle ridge |
| 36 | open end |
| 38 | recess shoulder |
| 40 | transition |

Where in the foregoing description reference has been made to ratios, integers, components or modules having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

What is claimed is:

1. A sealing gasket in combination with corresponding sealing groove(s), comprising:
a sealing gasket with a cross section having a plurality of lobes in a generally H-shaped configuration; and
a pair of sealing grooves formed in corresponding sealing surface(s);
each of the sealing groove(s) having a groove bottom between opposing groove side(s); the groove bottom having a middle ridge projecting towards an open end of the groove(s);
the sealing gasket compressing and sealing against the groove(s) as the sealing surfaces are mated against each another.

2. The combination of claim 1, wherein each groove side has a recess shoulder at the sealing surface.

3. The combination of claim 2, wherein the sealing gasket fills the sealing groove(s) and projects into the recess shoulder(s) when the sealing surface(s) are mated together.

4. The combination of claim 1, wherein the middle ridge separates each of the lobes, preventing lateral buckling of the lobes, as the sealing surface(s) are mated against each another.

5. The combination of claim 1, wherein the middle ridge has a height from the groove bottom of at least 25 percent of a depth of the sealing groove.

6. The combination of claim 1, wherein a width of the sealing gasket is less than a width of the sealing groove(s) and a height of the sealing gasket is greater than a combined depth of the sealing groove(s).

7. The combination of claim 1, wherein a first upward projecting lobe and a first downward projecting lobe of the sealing gasket is vertically aligned on a first side of the sealing gasket and a second upward projecting lobe and a second downward projecting lobe of the sealing gasket is vertically aligned on a second side of the sealing gasket.

8. The combination of claim 1, wherein the corresponding sealing surfaces are a first sealing surface with a first sealing groove and a second sealing surface with a second sealing groove;
a depth of the first sealing groove is greater than a depth of the second sealing groove; and
a width of the sealing gasket is less than a width of the first sealing groove and a height of the sealing gasket is greater than a combined depth of the first sealing groove and the second sealing groove.

9. The combination of claim 1, wherein the sealing groove(s) are formed via die casting.

10. The combination of claim 1, wherein the ridge has a generally triangular cross section.

11. The combination of claim 1, wherein a transition between each of the groove side(s) and the groove bottom, and between the groove bottom and the bottom ridge is rounded.

12. A sealing gasket adapted to mate with sealing groove(s) of corresponding sealing surfaces, the sealing groove(s) each having a groove bottom between opposing groove side(s); the groove bottom having a middle ridge projecting towards an open end of the groove, the sealing gasket comprising:
a length of compressible material adapted to mate with the sealing groove(s);
the compressible material having a cross section with a plurality of lobes in a generally H-shaped configuration.

13. The sealing gasket of claim 12, wherein a first upward projecting lobe and a first downward projecting lobe of the sealing gasket is vertically aligned on a first side of the sealing gasket and a second upward projecting lobe and a second downward projecting lobe of the sealing gasket is vertically aligned on a second side of the sealing gasket.

14. The sealing gasket of claim 12, wherein the compressible material is one of viton, silicon, epdm and rubber.

15. A pair of sealing grooves formed in corresponding sealing surfaces adapted to compress and seal against a generally H-shaped sealing gasket, each of the sealing groove(s) comprising:
a groove bottom between opposing groove side(s); the groove bottom having a middle ridge projecting towards an open end of the sealing groove;
the sealing gasket compressing and sealing against the groove(s) as the sealing surfaces are mated against each another.

16. The sealing groove(s) of claim 15, wherein each groove side has a recess shoulder at the sealing surface.

17. The sealing groove(s) of claim 15, wherein the middle ridge has a height from the groove bottom of at least 25 percent of a depth of the sealing groove.

18. The sealing groove(s) of claim 15, wherein the sealing grooves are formed via die casting.

19. The sealing groove(s) of claim 15, wherein the middle ridge has a generally triangular cross section.

20. The sealing groove(s) of claim 15, wherein a transition between each of the groove side(s) and the groove bottom, and between the groove bottom and the bottom ridge is rounded.
